(19) United States
(12) Patent Application Publication
(10) Pub. No.: US 2018/0123435 A1
(43) Pub. Date: May 3, 2018

(54) MOTOR ROTOR STRUCTURE WITH COPPER CONDUCTIVE BARS

(71) Applicant: NIO NEXTEV LIMITED, Hong Kong (CN)

(72) Inventors: Shixiang ZHANG, Shanghai (CN); Shengchuan ZHANG, Shanghai (CN); Liwen XU, Shanghai (CN); Zhaohui ZHUANG, Shanghai (CN); Peng LI, Shanghai (CN); Hongyu LAN, Shanghai (CN); Jingcai ZHANG, Shanghai (CN); Yalan TANG, Shanghai (CN)

(21) Appl. No.: 15/795,752

(22) Filed: Oct. 27, 2017

(30) Foreign Application Priority Data
Oct. 27, 2016 (CN) 201621179653.1

(51) Int. Cl. H02K 17/16; H02K 1/26; H02K 3/02; H02K 3/12

(52) U.S. Cl. CPC H02K 17/165; H02K 3/12; H02K 3/02; H02K 1/26

(57) ABSTRACT

The present application relates to the field of electric motor, particularly to a motor rotor structure with copper conductive bars. This application aims at solving the problem existed in the art, which is how to reduce stress concentration of the rotor iron core and how to avoid deformation of the copper end rings. The motor rotor structure of this application comprises a rotor iron core provided with rotor slots, copper conductive bars provided within the rotor slots, rotor end rings respectively provided at two ends of the rotor iron core. Each rotor end ring includes copper end rings and steel end rings. The copper end rings are alternately laminated with the steel end rings and welded together into a piece. Thanks to very high stiffness and resistance to large deforming force, the steel end rings provided between and compressed by the copper end rings ensure that the rotor end rings of the present application will not deform even at high rotating speed, thereby reducing stress concentration without compromising structural stiffness.

### CROSS-REFERENCE TO RELATED APPLICATIONS

This application claims the benefit of China Patent Application No. 201621179653.1 filed Oct. 27, 2016, the entire contents of which are incorporated herein by reference.

### TECHNICAL FIELD

The present application relates to the field of electric motors, particularly to a motor rotor structure with copper conductive bars.

### BACKGROUND

Copper rotor asynchronous electric motors are widely used as traction motors of high-power electric vehicles due to its high reliability and large speed range. The rotor slots of traditional copper conductive bar asynchronous electric motors are inserted with copper conductive bars and a copper end ring is provided at each end of the rotor. The copper end rings and the rotor have the same number of slots and the same radial size. Both ends of each copper conductive bar are respectively inserted into a respective slot of one of the two copper end rings, and all the conductive bars are fastened to the end rings by means of welding so that the copper conductive bars and the two end rings form a closed circuit. Copper rotor can effectively improve the efficiency and the power density of the traction motor thanks to copper's lower resistance and better heat conductivity than aluminum. When the motor operates at high speed, the high density nature of copper results in deformation of the copper end rings and stress concentration of the flux barriers at two sides of the rotor iron core.

Accordingly, there is a need in the art for a new rotor structure to solve the previously mentioned problem.

### SUMMARY

The present application aims at solving the above problem existed in the art, which is how to reduce stress concentration of the rotor iron core and how to avoid deformation of the copper end rings, the present application provides a motor rotor structure with copper conductive bars. The motor rotor structure comprises: a rotor iron core provided with rotor slots; copper conductive bars provided within the rotor slots; rotor end rings respectively provided at two ends of the rotor iron core; wherein each rotor end ring includes: at least one copper end ring provided with first end ring slots in its axis direction; at least one steel end ring provided with second end ring slots in its axis direction, the steel end ring is alternately laminated with the at least one copper end rings in its axis direction; wherein two ends of each copper conductive bar respectively pass through the first and second end ring slots.

In a preferred embodiment of the above motor rotor structure, the copper end rings are welded together into a piece.

In a preferred embodiment of the above motor rotor structure, each rotor end ring includes several steel end rings; in assembled state, one end of one end ring of the several steel end rings abuts on the rotor iron core.

In a preferred embodiment of the above motor rotor structure, in assembled state, the end ring farthest from the rotor iron core is a copper end ring.

In a preferred embodiment of the above motor rotor structure, the number of the first end ring slots and/or the second end ring slots is the same as that of the rotor slots; in assembled state, the first end ring slots and/or the second end ring slots are aligned with the rotor slots.

In a preferred embodiment of the above motor rotor structure, the radial size of the copper end rings and/or the steel end rings are the same as that of the rotor iron core.

In a preferred embodiment of the above motor rotor structure, the copper end rings and/or the steel end rings are of stamped laminate structure.

In a preferred embodiment of the above motor rotor structure, each rotor end ring includes five copper end rings and two steel end rings at each end of the rotor iron core.

In a preferred embodiment of the above motor rotor structure, counting from the end of the rotor iron core, the two steel end rings are respectively located at the first place and the second, fourth or fifth place.

In a preferred embodiment of the above motor rotor structure, the motor is an asynchronous electric motor.

It can be understood by those skilled in the art that in the preferred technical solutions of the application, the copper end rings are alternately laminated with the steel end rings and welded together into a piece. With very high stiffness and resistance to large deforming force, the steel end rings fixed between the copper end rings and compressed by the copper end rings ensure that the rotor end rings will not deform even at high rotating speed, thereby reducing stress concentration without compromising structural stiffness.

### BRIEF DESCRIPTION OF DRAWINGS

FIG. 1 is a schematic side illustration of a motor rotor structure with copper conductive bars of the present application;

FIG. 2 is an end view of the motor rotor structure with copper conductive bars of the present application;

FIG. 3 is an elevation view of the copper end rings of the motor rotor structure of the present application; and

FIG. 4 is an elevation view of the steel end rings of the motor rotor structure of the present application.

### DETAILED DESCRIPTION

The preferred embodiments of the application are described below with reference to the accompanying figures. As will be understood by those skilled in the art, these embodiments are simply used for interpreting the technical principle of the application and are not intended to limit its protection scope in any way. For example, although each member in the figures is drawn to scale, this proportional relation is merely exemplary in nature and can be modified as desired by skilled artisans to accommodate specific applications.

It should be pointed out that in the description of the application, such directional and positional terms as central, upper, lower, left, right, vertical, horizontal, inner and outer, given on the basis of the directional and positional relations shown in the drawings, are used to facilitate the description itself and does not express or imply the necessary specific positions or specific operational and structural positions of the devices or elements of the disclosure. Therefore, the usage is not to be construed as limitation on the application. Additionally, terms like first, second and third are merely provided for the purposes of description other than expressing or implying their relative importance.

Moreover, it should also be noted that in the description of the application, unless otherwise unambiguously specified and defined, the terms of install, connect and couple should be construed in their broad senses; for example they can be permanent or detachable or integrally connecting, mechanically or electrically connecting, directly connecting or indirectly connecting via a third part, or even connecting between the inner parts of two elements. It will be understood by those skilled in the art that the specific meanings of the above terms vary under different context.

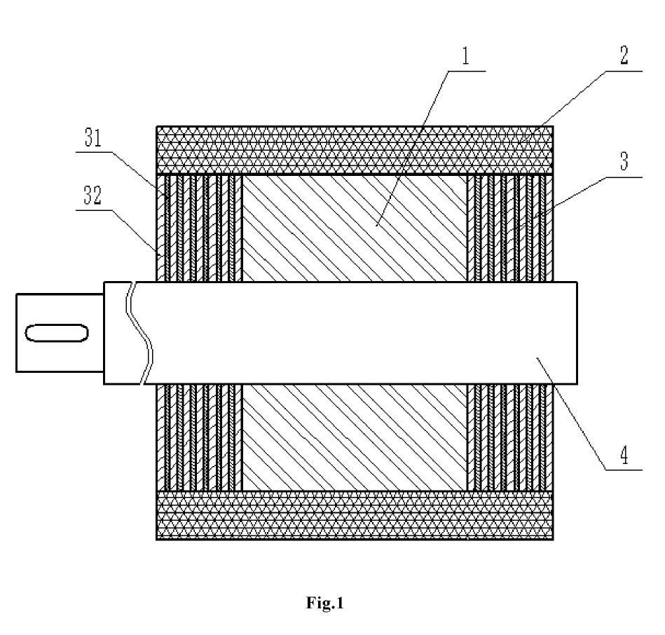

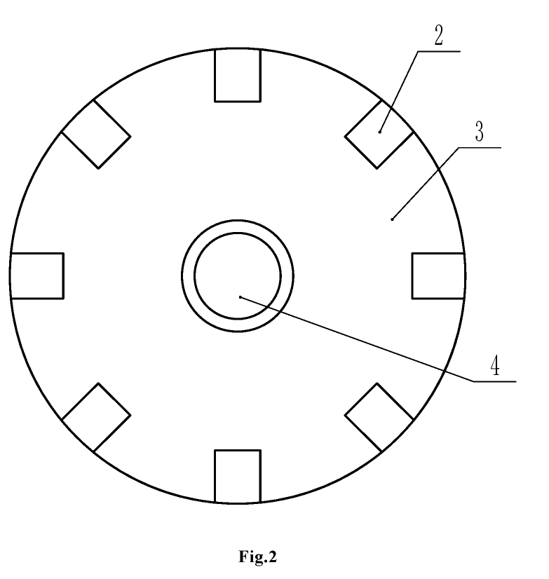

As shown in FIG. 1 and FIG. 2, a motor rotor structure with copper conductive bars of the present application comprises a rotor iron core 1, copper conductive bars 2, two end rings 3 and a rotor shaft 4. The rotor iron core 1 is provided with rotor slots (not shown in the accompanying drawings) within which the conductive bars 2 are fixed. The two end rings 3 are respectively located at two ends of the rotor iron core 1 (the left and right ends of the rotor iron core 1 shown in FIG. 1) and in fixed connection with two ends of each conductive bar 2. The rotor shaft 4 and the rotor iron core 1 are in coaxial and fixed connection (preferably, in an interference fit way) with each other.

As shown in FIG. 1, each end ring 3 includes copper end rings 31 and steel end rings 32 laminated alternately with the copper end rings 31. Further, the radial dimensions of the copper end rings 31 and the steel end rings 32 are the same as that of the rotor iron core 1 or variable by those skilled in the art as desired.

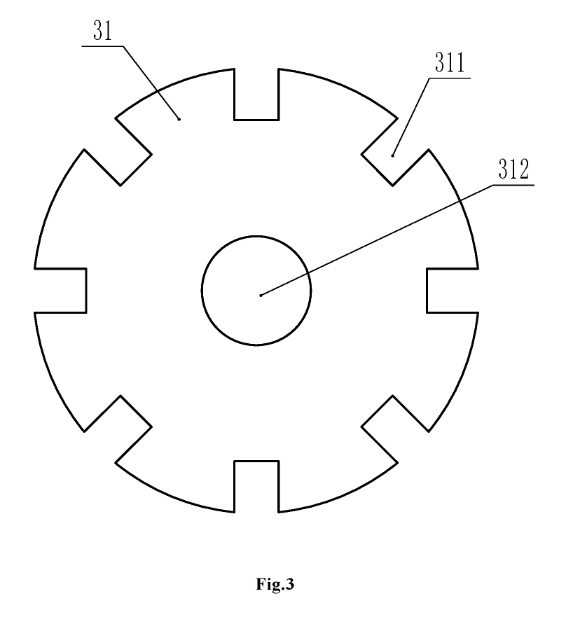

As shown in FIG. 2 and FIG. 3, each copper end ring 31 has a set of first end ring slots 311. Preferably, the number, shape and size of the first end ring slots 311 are the same as those of the rotor slots on the rotor iron core 1; and in assembled state the first end ring slots 311 and the rotor slots are aligned respectively such that the copper conductive bars 2 fixed within the rotor slots can pass through the first end ring slots 311. As can be understood by those skilled persons in the field, the number of the first end ring slots 311 can be greater than that of the rotor slots, and the size of the first end ring slots 311 can be larger or smaller than that of the rotor slots, as long as each conductive bar 2 can pass through and come into contact with a respective end ring slot 311 in the assembled state. Each copper end ring 31 is also provided at its axis with a first through hole 312, which enables the rotor shaft 4 to be inserted (preferably, in a clearance fit way) into the copper end ring 31. It should be readily understood by those skilled in the art that the clearance between the copper end rings 31 and the rotor shaft 4 should be small enough to avoid the copper end ring 31 loosening during high speed rotation. As can be understood by the skilled artisan, the copper end rings 31 and the rotor shaft 4 can be connected with each other in ways other than clearance fit, such as interference fit.

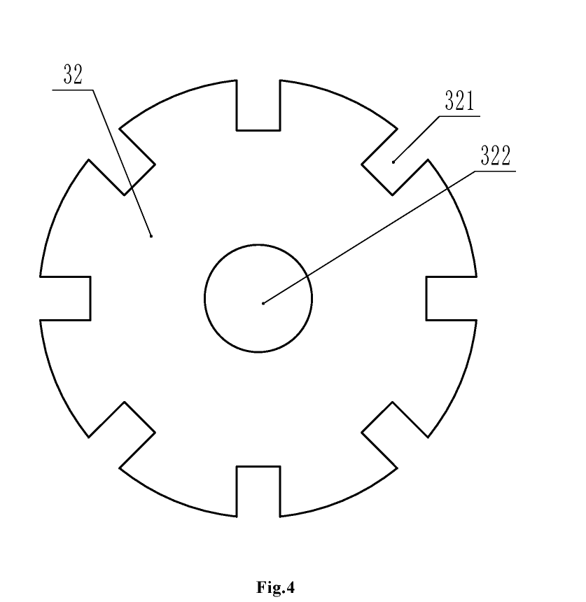

As shown in FIG. 2 and FIG. 4, each steel end ring 32 has a set of second end ring slots 321. Preferably, the number, shape and size of the second end ring slots 321 are the same as those of the rotor slots on the rotor iron core 1; and in assembled state the second end ring slots 321 and the rotor slots are aligned respectively such that the copper conductive bars 2 fixed within the rotor slots can pass through the second end ring slots 321. As can be understood by those skilled persons in the field, the number of the second end ring slots 321 can be greater than that of the rotor slots, and the size of the second end ring slots 321 can be larger or smaller than that of the rotor slots, as long as each conductive bar 2 can pass through and come into contact with a respective end ring slot 321 in the assembled state. Each steel end ring 32 is also provided at its axis with a second through hole 322, which enables the rotor shaft 4 to be inserted (preferably, in a clearance fit way) into the steel end ring 32. It should be readily understood by those skilled in the art that the clearance between the steel end rings 32 and the rotor shaft 4 should be small enough to avoid the steel end ring 32 loosening during high speed rotation. As can be understood by the skilled artisan, the steel end rings 32 and the rotor shaft 4 can be connected with each other in ways other than clearance fit, such as interference fit.

As shown in FIG. 1 and FIG. 2, when the rotor structure of this application is assembled as follows: first plugging all copper conductive bars 2 into the rotor slots, then inserting one steel end ring 32 onto the left ends of the copper conductive bars 2 (the left ends of the copper conductive bars 2 as shown in FIG. 2), and making the steel end ring 32 approach and come into contact with the end of the rotor iron core 1; inserting two copper end rings 31 and then one steel end ring 31 onto the left ends of the copper conductive bars 2; and finally plugging three copper end rings 31 onto the left ends of the conductive bars 2 and welding all copper end rings 31 together into a piece. The above steps are repeated so that copper end rings 31 and steel end rings 32 are put onto the right ends of the copper conductive bars 2 (the right ends of the copper conductive bars 2 shown in FIG. 1) and all copper end rings 32 are welded together into a piece. As can be understood by those skilled in the art, the copper end rings 31 and the steel end rings 32 can be arranged in ways other than the above alternately laminated manner; for example each copper end ring 31 is followed by one steel end ring 32. It is to be understood by the skilled artisan that the number of the copper end rings 31 and the steel end rings 32 can be determined as desired.

It should be pointed out that it is necessary to compress all copper and steel end rings 31 and 32 before welding the copper end rings 31 together, in order that during high speed rotation, all steel end rings 32 are able to be in complete contact with the copper end rings 31. It is to be understood by those skilled in the art that the stiffness of steel is higher than that of copper, deformation of the end rings 3 and stress concentration of the rotor iron core 1 are effectively reduced due to existence of the steel end rings 32.

As can also be understood by the skilled person in the art, the copper end rings 31 can be connected together by ways other than welding.

In a preferred embodiment of rotor structure of this application, the copper end rings 31 and the steel end rings 32 are stamped into laminates, and their thicknesses can be adjusted respectively by those skilled in the art as desired.

What is claimed is:

1. A motor rotor structure with copper conductive bars, comprising:
a rotor iron core provided with rotor slots;
copper conductive bars provided within the rotor slots;
rotor end rings respectively provided at two ends of the rotor iron core;
wherein each rotor end ring includes:
at least one copper end ring provided with first end ring slots in its axis direction;
at least one steel end ring provided with second end ring slots in its axis direction, the steel end ring is alternately laminated with the at least one copper end rings in its axis direction;
wherein two ends of each copper conductive bar respectively pass through the first and second end ring slots.

2. The motor rotor structure with copper conductive bars as set forth in claim 1, wherein the copper end rings are welded together into a piece.

3. The motor rotor structure with copper conductive bars as set forth in claim 2, wherein each rotor end ring includes several steel end rings; in assembled state, one end of one end ring of the several steel end rings abuts on the rotor iron core.

4. The motor rotor structure with copper conductive bars as set forth in claim 3, wherein in assembled state, the end ring farthest from the rotor iron core is a copper end ring.

5. The motor rotor structure with copper conductive bars as set forth in claim 4, wherein the number of the first end ring slots and/or the second end ring slots is the same as that of the rotor slots; in assembled state, the first end ring slots and/or the second end ring slots are aligned with the rotor slots.

6. The motor rotor structure with copper conductive bars as set forth in claim 5, wherein the radial size of the copper end rings and/or the steel end rings are the same as that of the rotor iron core.

7. The motor rotor structure with copper conductive bars as set forth in claim 6, wherein the copper end rings and/or the steel end rings are of stamped laminate structure.

8. The motor rotor structure with copper conductive bars as set forth in claim 1, wherein each rotor end ring includes five copper end rings and two steel end rings at each end of the rotor iron core.

9. The motor rotor structure with copper conductive bars as set forth in claim 8, wherein counting from the end of the rotor iron core, the two steel end rings are respectively located at the first place and the second, fourth or fifth place.

10. The motor rotor structure with copper conductive bars as set forth in claim 9, wherein the motor is an asynchronous electric motor.

11. The motor rotor structure with copper conductive bars as set forth in claim 2, wherein each rotor end ring includes five copper end rings and two steel end rings at each end of the rotor iron core.

12. The motor rotor structure with copper conductive bars as set forth in claim 3, wherein each rotor end ring includes five copper end rings and two steel end rings at each end of the rotor iron core.

13. The motor rotor structure with copper conductive bars as set forth in claim 4, wherein each rotor end ring includes five copper end rings and two steel end rings at each end of the rotor iron core.

14. The motor rotor structure with copper conductive bars as set forth in claim 5, wherein each rotor end ring includes five copper end rings and two steel end rings at each end of the rotor iron core.

15. The motor rotor structure with copper conductive bars as set forth in claim 6, wherein each rotor end ring includes five copper end rings and two steel end rings at each end of the rotor iron core.

16. The motor rotor structure with copper conductive bars as set forth in claim 7, wherein each rotor end ring includes five copper end rings and two steel end rings at each end of the rotor iron core.

17. The motor rotor structure with copper conductive bars as set forth in claim 11, wherein counting from the end of the rotor iron core, the two steel end rings are respectively located at the first place and the second, fourth or fifth place.

18. The motor rotor structure with copper conductive bars as set forth in claim 12, wherein counting from the end of the rotor iron core, the two steel end rings are respectively located at the first place and the second, fourth or fifth place.

19. The motor rotor structure with copper conductive bars as set forth in claim 13, wherein counting from the end of the rotor iron core, the two steel end rings are respectively located at the first place and the second, fourth or fifth place.

20. The motor rotor structure with copper conductive bars as set forth in claim 14, wherein counting from the end of the rotor iron core, the two steel end rings are respectively located at the first place and the second, fourth or fifth place.
